(19) United States
(12) Patent Application Publication
(10) Pub. No.: US 2018/0032971 A1
(43) Pub. Date: Feb. 1, 2018

(54) SYSTEM AND METHOD FOR PREDICTING RELEVANT RESOLUTION FOR AN INCIDENT TICKET

(71) Applicant: Wipro Limited, Bangalore (IN)

(72) Inventors: Selvakuberan Karuppasamy, Chennai (IN); Amit Thapak, Pune (IN)

(21) Appl. No.: 15/270,953

(22) Filed: Sep. 20, 2016

(30) Foreign Application Priority Data
Jul. 29, 2016 (IN) 201641026094

(51) Int. Cl. G06Q 10/00; G06N 99/00; G06N 5/04

(52) U.S. Cl. CPC G06Q 10/20; G06N 5/04; G06N 99/005

(57) ABSTRACT

This disclosure relates generally to incident ticket management, and more particularly to system and method for predicting relevant resolution for an incident ticket. In one embodiment, a method is provided for predicting a relevant resolution for an incident ticket. The method comprises receiving the incident ticket, analyzing the incident ticket to determine at least one query Ngram and at least one category, determining a similar past incident ticket based on a comparison of the at least one query Ngram and at least one Ngram derived from each of a plurality of past incident tickets belonging to the at least one category, and predicting the relevant resolution based on one or more resolution mapped to the similar past incident ticket.

This application claims the benefit of Indian Patent Application Serial No. 201641026094 filed Jul. 29, 2016 which is hereby incorporated by reference in its entirety.

### FIELD

This disclosure relates generally to incident ticket management, and more particularly to system and method for predicting relevant resolution for an incident ticket.

### BACKGROUND

Advancements in the field of Information Technology (IT) have enabled digitization of various processes and activities in an industry or an enterprise. However, to derive the benefits of digitization the IT infrastructures need to run smoothly. Additionally, an efficient incident ticket management system is required to provide a quick resolution to any user queries or any incident ticket with respect to the IT infrastructures. The incident ticket may include an issue or a problem that a user face at the hardware and/or software level, or may also include a request for information on the hardware and/or software.

The incident ticket management system takes user queries as input (i.e., incident tickets), categorizes the tickets into various classes, and routes the tickets to the concerned team for resolution based on the classification. Typically, there are separate teams (e.g., L1 or L2 service team) to co-ordinate with end users and to resolve the incident tickets. Once the resolution is done, the ticket is closed. In current techniques, upon submitting the ticket, the system may pick the keywords or error symptoms from the ticket description so as to route the ticket to the concerned team and may also suggest similar type of past tickets (that are already resolved). This enables the resolution team to resolve the tickets at a faster rate.

However, the current system is limited in that it may not capture the error symptoms accurately such as when the same type of error symptoms is across multiple applications. For example, “browser issue” can be across different browsers such as Internet Explorer, Mozilla, Chrome, Opera, etc. Additionally, the current system is limited if the information provided by the user is unclear or incomplete. Further, the similar past resolved tickets suggested by the system may be off the mark in certain cases. For example, the suggestions for “Outlook not working” may be ‘Outlook configuration error’ or ‘Outlook memory error’. These recommendations may not provide any correct response for the exact issue the user may be facing. In all such cased, the resolution team has to come back to the user and clarify the problem. Thus, despite much advancement the resolutions provided by the support team are at times delayed and/or not accurate. These limitations, in turn, affect the overall functioning of the organization or the enterprise.

### SUMMARY

In one embodiment, a method for predicting a relevant resolution for an incident ticket is disclosed. In one example, the method comprises receiving the incident ticket. The method further comprises analyzing the incident ticket to determine at least one query Ngram and at least one category. The method further comprises determining a similar past incident ticket based on a comparison of the at least one query Ngram and at least one Ngram derived from each of a plurality of past incident tickets belonging to the at least one category. The method further comprises predicting the relevant resolution based on one or more resolution mapped to the similar past incident ticket.

In one embodiment, a system for predicting a relevant resolution for an incident ticket is disclosed. In one example, the system comprises at least one processor and a memory communicatively coupled to the at least one processor. The memory stores processor-executable instructions, which, on execution, cause the processor to receive the incident ticket. The processor-executable instructions, on execution, further cause the processor to analyze the incident ticket to determine at least one query Ngram and at least one category. The processor-executable instructions, on execution, further cause the processor to determine a similar past incident ticket based on a comparison of the at least one query Ngram and at least one Ngram derived from each of a plurality of past incident tickets belonging to the at least one category. The processor-executable instructions, on execution, further cause the processor to predict the relevant resolution based on one or more resolution mapped to the similar past incident ticket.

In one embodiment, a non-transitory computer-readable medium storing computer-executable instructions for predicting a relevant resolution for an incident ticket is disclosed. In one example, the stored instructions, when executed by a processor, cause the processor to perform operations comprising receiving the incident ticket. The operations further comprise analyzing the incident ticket to determine at least one query Ngram and at least one category. The operations further comprise determining a similar past incident ticket based on a comparison of the at least one query Ngram and at least one Ngram derived from each of a plurality of past incident tickets belonging to the at least one category. The operations further comprise predicting the relevant resolution based on one or more resolution mapped to the similar past incident ticket.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for predicting relevant resolution for an incident ticket in accordance with some embodiments of the present disclosure.

FIG. 2 is a functional block diagram of incident ticket prediction engine in accordance with some embodiments of the present disclosure.

FIG. 3 is a flow diagram of an exemplary process overview for predicting relevant resolution for an incident ticket in accordance with some embodiments of the present disclosure.

FIG. 4 is a flow diagram of an exemplary process for predicting relevant resolution for an incident ticket in accordance with some embodiments of the present disclosure.

FIG. 5 is a flow diagram of a detailed exemplary process for predicting relevant resolution for an incident ticket in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

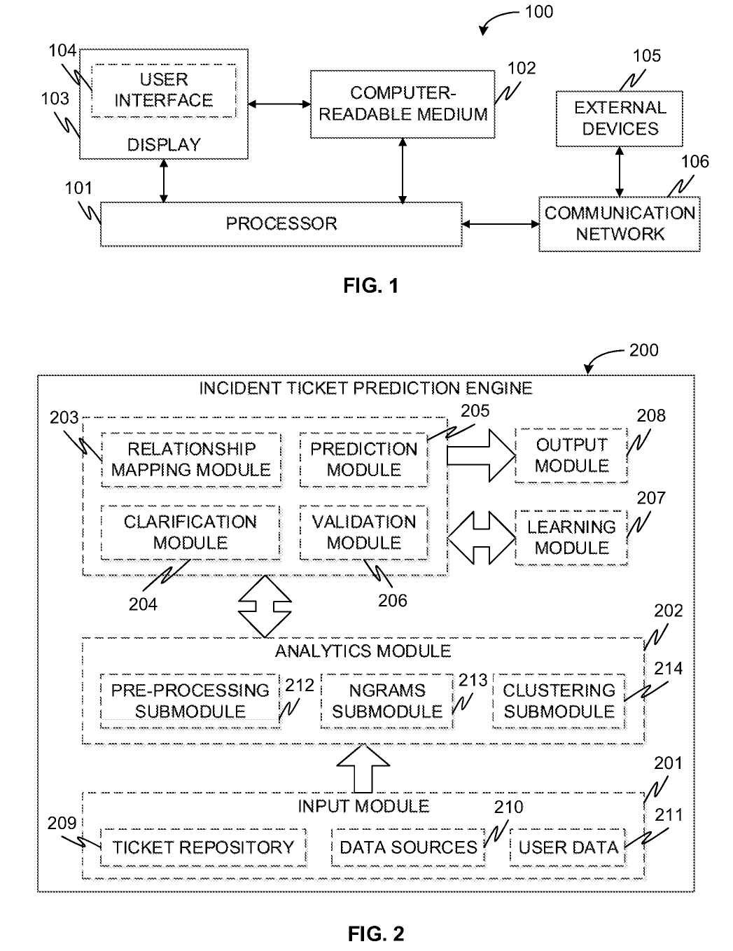

Referring now to FIG. 1, an exemplary system 100 for predicting relevant resolution for an incident ticket is illustrated in accordance with some embodiments of the present disclosure. In particular, the system 100 implements an incident ticket prediction engine to predict most relevant resolutions for incident tickets. As will be described in greater detail in conjunction with FIG. 2, the incident ticket prediction engine receives an incident ticket, analyzes the incident ticket to determine at least one query Ngram and at least one category, determines a similar past incident ticket based on a comparison of the at least one query Ngram and at least one Ngram derived from each of a plurality of past incident tickets belonging to the at least one category, and predicts the relevant resolution based on one or more resolution mapped to the similar past incident ticket.

The system 100 comprises one or more processors 101, a computer-readable medium (e.g., a memory) 102, and a display 103. The computer-readable storage medium 102 stores instructions that, when executed by the one or more processors 101, cause the one or more processors 101 to perform prediction of relevant resolutions for incident tickets in accordance with aspects of the present disclosure. The computer-readable storage medium 102 may also store various data (e.g., past ticket repository, keywords, Ngrams, clusters or categories, relationship mapping, user queries, resolutions, etc.) that may be captured, processed, and/or required by the system 100. The system 100 interacts with a user via a user interface 104 accessible via the display 103. The system 100 may also interact with one or more external devices 105 over a communication network 106 for sending or receiving various data. The external devices 105 may include, but are not limited to, a remote server, a digital device, or another computing system.

Referring now to FIG. 2, a functional block diagram of the incident ticket prediction engine 200 implemented by the system 100 of FIG. 1 is illustrated in accordance with some embodiments of the present disclosure. The incident ticket prediction engine 200 may include various modules that perform various functions so as to predict and provide relevant resolution to incident ticket. In some embodiments, the incident ticket prediction engine 200 comprises an input module 201, an analytics module 202, a relationship mapping module 203, a clarification module 204, a prediction module 205, a validation module 206, a learning module 207, and an output module 208.

The input module 201 receives input from one or more sources that enables the engine 200 to build a prediction model for predicting an appropriate resolution for an incident ticket. The input may include ticket repository 209, input from data sources 210, and input from a user or user data 211. The ticket repository or ticket dump 209 comprises data related to past incident tickets and corresponding resolutions. In some embodiments, it may be in the form of comma-separated values (CSV) file or Microsoft excel file and may include a number of fields or parameters such as a ticket ID or ticket number, a primary application, a title, a ticket description or a problem description, a resolution category, a resolution description, and so forth. The data sources 210 may include one or more personnel from a L1 and/or a L2 service team who resolves the assigned incident tickets. They are typically within the functions of the organization but may also be from outside service provider. The input from data sources 210 may include various other parameters such as resolution date and time, etc. The user data 211 may be the input from the user i.e. user query in the form of incident tickets. The summary of the user's problem may be provided in the description of the ticket.

The analytics module 202 may typically include a pre-processing submodule 212, an Ngrams submodule 213, and a clustering submodule 214. The pre-processing submodule 212 extracts the structured description from the ticket repository 209 in order to generate the prediction model. In particular, the pre-processing submodule 212 processes the problem descriptions and the resolution descriptions from the ticket repository to generate corresponding structured descriptions. In some embodiments, the pre-processing may include, but is not limited to, removing URLs, removing numbers, removing generic stop words, removing custom stop words, removing Emails, removing special characters, removing date and time values, and so forth as they have little or no contribution to content, context, and meaning of the ticket. Further, in some embodiments, the pre-processing may involve extracting the specific information needed from form based or Email based patterns using regex. Similarly, the pre-processing module 212 processes the problem description from the user query (i.e., the incident ticket) to generate the corresponding structured description.

The Ngrams submodule 213 generates the Ngrams from the structured description that effectively enable the identification of error symptoms in past incident tickets as well as in the user query. The term Ngrams refers to continuous sequence of N words in a given structured description. In some embodiments, the Ngrams submodule 213 may determine at least one of unigrams (1 word sequence), bigrams (2 words sequence), and trigrams (3 words sequence). The clustering submodule 214 clusters tickets into multiple categories such that each category comprises a set of tickets having at least one common characteristic. In other words, the clustering submodule 214 forms clusters or groups of tickets that belong to same application or the tickets having similar problem query.

The relationship mapping module 203 maps each of the past incident tickets with the one or more existing resolutions by analyzing the corresponding Ngrams. The mapping module 203 iteratively matches the Ngrams for each of the existing resolutions with the Ngrams for each of the past incident tickets. The mapping module 203 then scores each of the existing resolutions for a given past incident ticket based on a number of matches and selects the one or more resolutions from the plurality of resolutions based on scoring. In case of a conflict between the one or more resolutions having an identical score, the mapping module 203 may request clarification from a service user (i.e., resolution team) via the clarification module 204.

Additionally, the clarification module 204 may request an end user for any clarifications or for some other details (if required) so as to process the user tickets. For example, the clarification module 204 may request clarification from an end user (i.e., user raising the incident ticket or query) when the query is unclear or improper. The clarification module 204 may also request additional information from the end user so as to provide the appropriate solution.

The prediction module 205 builds a prediction model based on the Ngrams and the clusters. It performs mapping of the clusters and the Ngrams of tickets repository comprising of past tickets and existing solutions such that the resulting prediction model may be employed for predicting resolution for future tickets. In some embodiments, the prediction model may analyze the incident ticket to determine query Ngrams and one or more categories to which the incident ticket may fall into. The prediction model may then determine a similar past incident ticket based on a comparison of the query Ngrams and Ngrams derived from the past incident tickets belonging to the each of the one or more identified categories. The prediction model may then predict the relevant resolution based on one or more resolution mapped to the similar past incident ticket.

The validation module or the model trainer 206 in conjunction with the learning module 207 performs continuous validation and improvement of the predictive model. The learning module 207 employs a learning agent based on machine learning techniques to enable incremental learning. Thus, in some embodiments, upon receiving a user query (a new incident ticket), the prediction module 205 predicts a relevant resolution via the prediction model while the validation module 206 validates the relevant resolution provided by the prediction model with the help of a service level user. For a negative validation (i.e., the predicted resolution not being relevant or accurate), the learning module 207 initiates a learning process based on intelligence gathered manual resolution of the incident ticket. The new incident ticket and the corresponding manual resolution is updated in the repository for subsequent use. It should be noted that the incident ticket resulting in the negative validation is typically a new incident ticket unrelated to a plurality of past incident tickets and/or an incident ticket not having a mapped resolution. However, for a positive validation, the output module 208 presents the relevant resolution to the end user.

It should be noted that the incident ticket prediction engine 200 may be implemented in programmable hardware devices such as programmable gate arrays, programmable array logic, programmable logic devices, and so forth. Alternatively, the incident ticket prediction engine 200 may be implemented in software for execution by various types of processors. An identified engine of executable code may, for instance, comprise one or more physical or logical blocks of computer instructions which may, for instance, be organized as an object, procedure, function, module, or other construct. Nevertheless, the executables of an identified engine need not be physically located together, but may comprise disparate instructions stored in different locations which, when joined logically together, comprise the engine and achieve the stated purpose of the engine. Indeed, an engine of executable code could be a single instruction, or many instructions, and may even be distributed over several different code segments, among different applications, and across several memory devices.

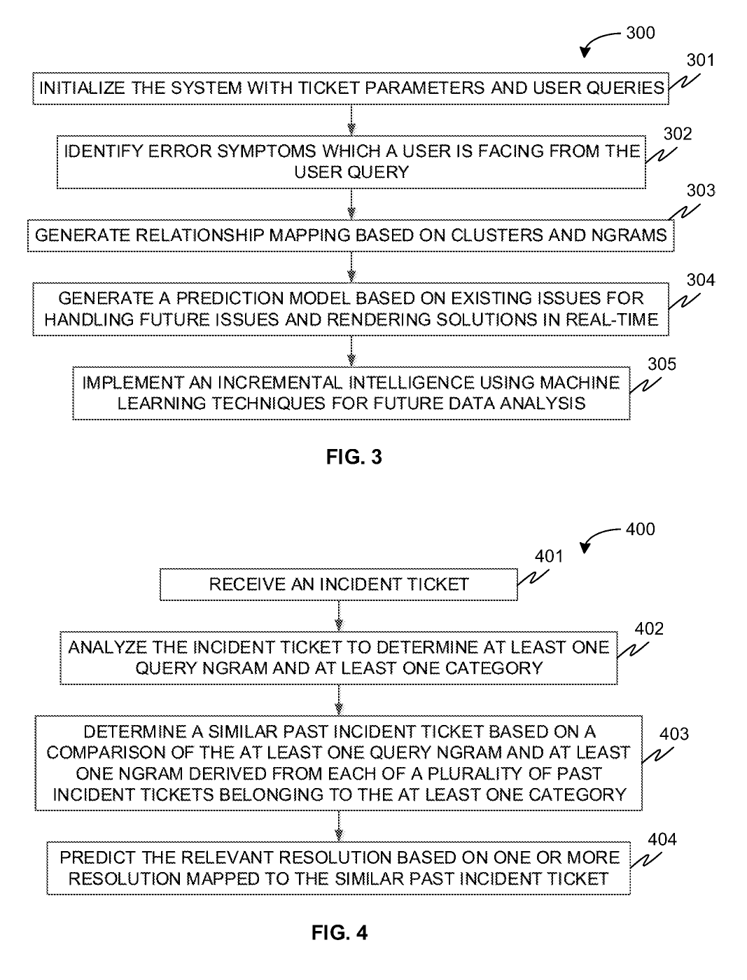

Referring now to FIG. 3, an overview of an exemplary process 300 for predicting relevant resolution for an incident ticket is depicted via a flowchart in accordance with some embodiments of the present disclosure. The process 300 involves the steps of initializing the system with ticket parameters and user queries at step 301, identifying error symptoms which a user is facing from the user query at step 302, generating relationship mapping based on clusters and Ngrams at step 303, generating a prediction model based on the existing issues for handling the future issues and rendering appropriate resolutions in real-time at step 304, and implementing an incremental intelligence using machine learning techniques for future data analysis at step 305. Each of these steps will be described in greater detail herein below.

At step 301, the system is initialized with the ticket repository or ticket dumps. In some embodiments, the ticket repository may include tickets from past two, three, or six months and corresponding resolutions. In some embodiments, the system may be initialized with additional parameters such as resolution date, resolution time, and assigned service personnel and so forth. Further, the system may be provided with a user query mentioning issues being faced by the user in the form of an incident ticket as input.

At step 302, the pre-processing submodule in conjunction with the Ngrams submodule and the clustering submodule identifies the error symptoms that the user is facing from the user query. The pre-processing submodule has built-in natural language processing (NLP) and text analyzer components. These components analyze the user data by removing the junks, spam, and stop words and by identifying the co-reference relationship between the sentences. The output from these components may be the keywords and named entities that may be subsequently clustered into various categories.

The NLP component receives the user query as input. The NLP component further captures the user utterances in the ticket logs and processes it. The processing of the text include identification of the individual sentences, tokenization of the sentence in the text, identification of the named entities like name of the places, organization, currency, time, date, and so forth. Also, NLP component may be employed to identify the noun and verb phrases in the sentence. Thus, the NLP component determines the relationship between the sentences in the service ticket and identifies the nouns and pronouns that describe the problem. The text analyzer component removes the unwanted junks from the user query. The text analyzer helps in the identification of keywords from the user query. The NLP component and the text analyzer component combines to form the necessary named entities and keywords that enable the identification of the clusters for the particular query or the incident ticket.

Thus, in some embodiments, by passing the user utterance to NLP and text analyzer component, the output will be the keywords from the user utterances. The output from the pre-processing submodule may then be provided to the Ngrams submodule and the clustering submodule to identify the groups the user utterance may be mapped to. In other words, the user query is processed to get the clusters and error symptoms as Ngrams.

At step 303, relationship mapping between the incident ticket and resolutions is generated based on clusters and Ngrams. The problem description in the ticket dumps is pre-processed and Ngrams are generated. Similarly the resolution description in the ticket dumps is pre-processed and Ngrams are generated. The relationship mapping module then maps the one or more resolutions to each incident ticket by iteratively matching the Ngrams of problem description with the Ngrams of resolution descriptions and the scoring the resolutions based on the number of matches. Thus, given an Ngrams (question), the relationship mapping module analyzes the possible Ngrams (solutions) to match the Ngrams (question). For example, Ngrams (question) may be {browser, browser issue, internet browser issue} for an input user query “I am facing internet browser issue”. However, if multiple solutions are coming out with the same score, then the relationship mapping module requests the clarification module to request the user for clarification.

At step 304, a prediction model is built based on the existing issue for handling the future issues and rendering the solution at real-time. The output from step 302 and 303 may be keywords, Ngrams, clusters, and mappings. The prediction model may therefore be built in such a way that the clusters may group the tickets based on common characteristics. It should be noted that the clusters simplify the role of relationship mapping and makes it efficient and effective. The relationship mapping may then provide a mapping of the Ngrams of ticket description and the resolution description within each cluster.

Thus, in some embodiments, given a ticket dump with problem description and the corresponding resolution description, the process of building prediction model involves clustering the tickets into groups based on the application names. The process of building prediction model further involves generating Ngrams for problem description and the corresponding resolution description. The process of building prediction model further involves generating a mapping of Ngrams for the problem and the corresponding resolution in a given cluster. The process of building prediction model further involves checking whether the Ngrams in problem description (any ticket) matches with Ngrams in problem description (rest of tickets) in any iteration. Similar Ngrams of the problem description are grouped and mapped with the resolution description to understand the error symptoms and the resolution mapping. The resultant prediction model may then be trained and validated by the validation module or the model trainer such that the prediction model provides most relevant and appropriate resolution for the user query.

At step 305, an incremental intelligence may be implemented using machine learning techniques for future data analysis. The entire system may be monitored by the intelligent agent and the system learns from the user's behavior and with the existing data. From the user query entering the system till the user gets the response output, the intelligent agent captures the data and learns incrementally to aid the actual learning of the system.

As will be appreciated by one skilled in the art, a variety of processes may be employed for predicting relevant resolution for an incident ticket. For example, the exemplary system 100 and the associated incident ticket prediction engine 200 may predict relevant resolution for an incident ticket by the processes discussed herein. In particular, as will be appreciated by those of ordinary skill in the art, control logic and/or automated routines for performing the techniques and steps described herein may be implemented by the system 100 and the associated incident ticket prediction engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

For example, referring now to FIG. 4, exemplary control logic 400 for predicting relevant resolution for an incident ticket via a system, such as system 100, is depicted via a flowchart in accordance with some embodiments of the present disclosure. As illustrated in the flowchart, the control logic 400 includes the steps of receiving the incident ticket at step 401, analyzing the incident ticket to determine at least one query Ngram and at least one category at step 402, and determining a similar past incident ticket based on a comparison of the at least one query Ngram and at least one Ngram derived from each of a plurality of past incident tickets belonging to the at least one category at step 403. The control logic 400 further includes the step of predicting the relevant resolution based on one or more resolution mapped to the similar past incident ticket at step 404. In some embodiments, analyzing the incident ticket at step 401 comprises pre-processing the incident ticket. Further, in some embodiments, pre-processing the incident ticket comprises extracting a plurality of keywords from the incident ticket.

In some embodiments, the control logic 400 may further include the steps of validating the relevant resolution from a user, and for a negative validation, initiating a learning process based on intelligence gathered manual resolution of the incident tick. It should be noted that the incident ticket resulting in the negative validation is a new incident ticket unrelated to a plurality of past incident tickets and not having a mapped resolution. The control logic 400 may further include the step of updating a ticket repository based on the learning process.

In some embodiments, the control logic 400 may further include the steps of receiving a past ticket repository comprising a plurality of past incident tickets and a plurality of resolutions, and clustering the plurality of past incident tickets and the plurality of resolutions into a plurality of categories. It should be noted that each category comprises a set of past incident tickets from the plurality of past incident tickets having at least one common characteristic. The control logic 400 may further include the steps of determining at least one Ngram for each of the plurality of past incident tickets and for each of the plurality of resolutions, and mapping each of the plurality of past incident tickets with the one or more resolutions from the plurality of resolutions by analyzing the at least one Ngram for each of the plurality of past incident tickets with the at least one Ngram for each of the plurality of resolutions. In some embodiments, the control logic 400 may further include the step of pre-processing the plurality of past incident tickets and the plurality of resolutions. In some embodiments analyzing Ngrams comprises iteratively matching the at least one Ngram for each of the plurality of resolutions with the at least one Ngram for each of the plurality of past incident tickets, and for a given past incident ticket from the plurality of past incident tickets, scoring each of the plurality of resolutions based on a number of matches, and selecting the one or more resolutions from the plurality of resolutions based on scoring. In some embodiments, the control logic 400 may further include the step of requesting clarification from a user in case of a conflict between the one or more resolutions having an identical score.

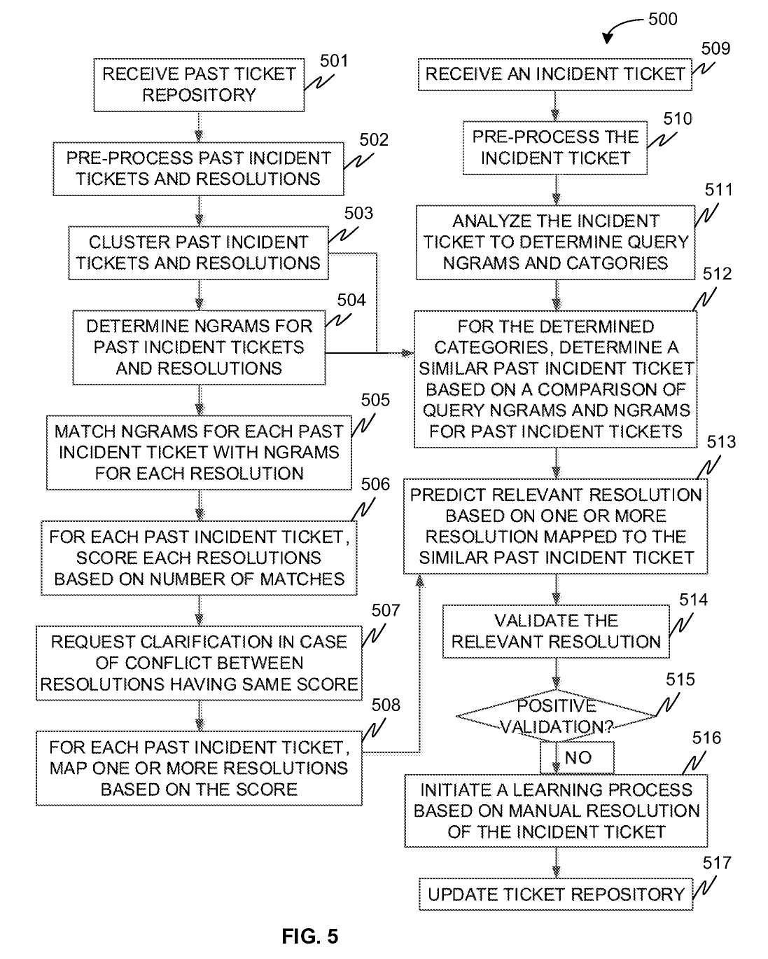

Referring now to FIG. 5, exemplary control logic 500 for predicting relevant resolution for an incident ticket is depicted in greater detail via a flowchart in accordance with some embodiments of the present disclosure. As illustrated in the flowchart, the control logic 500 includes the steps of receiving past ticket repository comprising of past incident tickets and corresponding resolutions at step 501, pre-processing the past incident tickets and the resolutions at step 502, and clustering the past incident tickets and resolutions into multiple categories at step 503. The control logic 500 further includes the steps of determining Ngrams for past incident tickets and resolutions at step 504, matching Ngrams for each past incident ticket with Ngrams for each resolution at step 505, and for each past incident ticket, scoring each resolutions based on number of matches at step 506. The control logic 500 further includes the step of requesting clarification from a user on case of a conflict between resolutions having same score at step 507. The control logic 500 further includes the step of mapping each past incident ticket with one or more resolutions based on the score at step 508.

Additionally, the control logic 500 includes the steps of receiving an incident ticket from a user at step 509, pre-processing the incident ticket at step 510, analyzing the incident ticket to determine query Ngrams as well as one or more categories to which the incident ticket may belong to at step 511. For each of the one or more determined categories, the control logic 500 further includes the step of determining a similar past incident ticket based on a comparison of query Ngrams and Ngrams for past incident tickets at step 512. It should be noted that, in some embodiments, the determination at step 512 involves referring to the clusters and Ngrams derived from the ticket repository at steps 503 and 504. Alternatively, it should be noted that, in some embodiments, the clusters and Ngrams derived from a repository of past incident tickets and resolutions may be separately received from an external source and therefore need not be derived by the control logic 500. The control logic 500 further includes the step of predicting relevant resolution for the incident ticket based on one or more resolution mapped to the similar past incident ticket at step 513. Again, it should be noted that, in some embodiments, the prediction at step 513 involves referring to the mapping derived at step 508. Alternatively, it should be noted that, in some embodiments, the mapping may be separately derived and thereupon fed from an external source.

Moreover, the control logic 500 includes the steps of validating the relevant resolution at step 514, and determining if the validation is a positive validation or not at step 515. If the resolution provided is accurate and relevant then it is a positive validation and the control logic 500 concludes by recording as such. However, if the resolution provided is not accurate and/or not relevant then it is a negative validation. In such cases, the incident ticket is taken for manual resolution. Further, in such cases, the control logic 500 includes the steps of initiating a learning process based on the manual resolution of the incident ticket at step 516, and updating the ticket repository with the incident ticket as well as its resolution at step 517.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

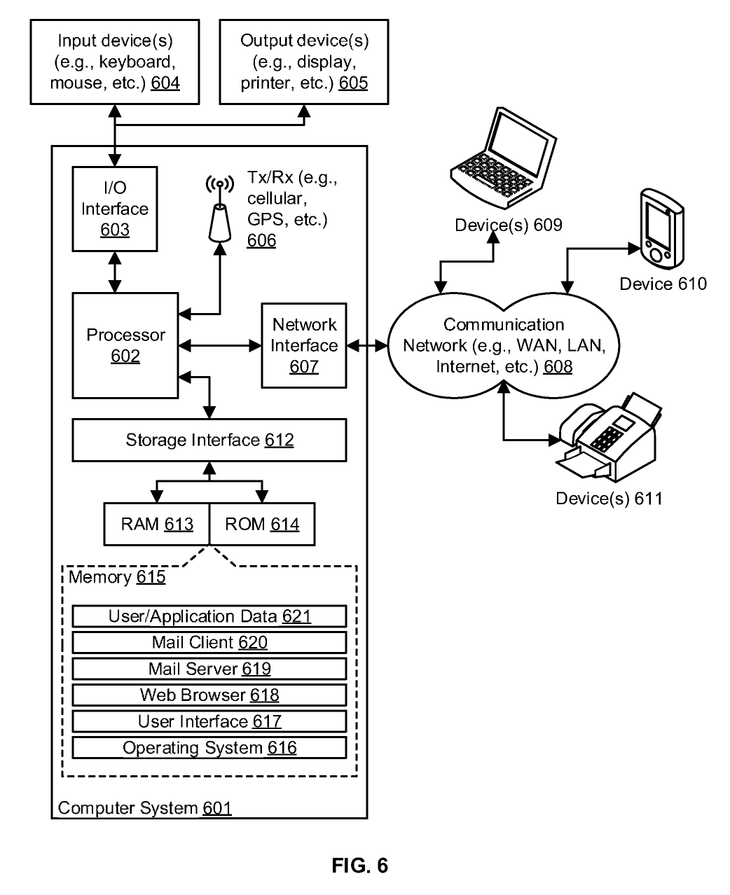

The disclosed methods and systems may be implemented on a conventional or a general-purpose computer system, such as a personal computer (PC) or server computer. Referring now to FIG. 6, a block diagram of an exemplary computer system 601 for implementing embodiments consistent with the present disclosure is illustrated. Variations of computer system 601 may be used for implementing system 100 and incident ticket prediction engine 200 for predicting relevant resolution for an incident ticket. Computer system 601 may comprise a central processing unit (“CPU” or “processor”) 602. Processor 602 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. (e.g., past ticket repository, keywords, Ngrams, clusters or categories, relationship mapping, user queries, resolutions, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above result in automated, efficient, and speedy resolution of incident tickets. The techniques provide for a prediction model derived from past tickets repository that can predict the most appropriate or relevant resolution for an incident ticket in real-time, thereby reducing the manual effort and the time delay in providing accurate resolution. Further, the techniques described in the various embodiments discussed above increase the productivity of the user as well as the resolution team handling those tickets. The user can have quick resolution to his query while the resolution team may focus on new issues for which there are no mapped resolutions.

Additionally, as will be appreciated by those skilled in the art, the prediction model learns new errors and tries to map the resolutions for the new errors. The prediction model understands the relationship between the error and the cluster/group in which the error would belong to by continuous learning. Further, the prediction model may analyze a number of times same error is being faced by the users in a given period of time and other such information. Such information may be very useful in not only improving the prediction model but also the overall IT infrastructure.

The specification has described system and method for predicting relevant resolution for an incident ticket. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for predicting a relevant resolution for an incident ticket, the method comprising:
receiving, via an incident ticket prediction device, the incident ticket;
analyzing, via the incident ticket prediction device, the incident ticket to determine at least one query Ngram and at least one category;
determining, via the incident ticket prediction device, a similar past incident ticket based on a comparison of the at least one query Ngram and at least one Ngram derived from each of a plurality of past incident tickets belonging to the at least one category; and
predicting, via the incident ticket prediction device, the relevant resolution based on one or more resolution mapped to the similar past incident ticket.

2. The method of claim 1, wherein the analyzing the incident ticket comprises pre-processing the incident ticket.

3. The method of claim 2, wherein the pre-processing comprises extracting a plurality of keywords from the incident ticket.

4. The method of claim 1, further comprising:
validating the relevant resolution from a user;
for a negative validation, initiating a learning process based on intelligence gathered manual resolution of the incident ticket, wherein the incident ticket resulting in the negative validation is a new incident ticket unrelated to a plurality of past incident tickets and not having a mapped resolution; and
updating a ticket repository based on the learning process.

5. The method of claim 1, further comprising:
receiving a past ticket repository comprising a plurality of past incident tickets and a plurality of resolutions;
clustering the plurality of past incident tickets and the plurality of resolutions into a plurality of categories, wherein each category comprises a set of past incident tickets from the plurality of past incident tickets having at least one common characteristic;
determining at least one Ngram for each of the plurality of past incident tickets and for each of the plurality of resolutions;
mapping each of the plurality of past incident tickets with the one or more resolutions from the plurality of resolutions by analyzing the at least one Ngram for each of the plurality of past incident tickets with the at least one Ngram for each of the plurality of resolutions.

6. The method of claim 5, further comprising pre-processing the plurality of past incident tickets and the plurality of resolutions.

7. The method of claim 5, wherein the analyzing comprises:
iteratively matching the at least one Ngram for each of the plurality of resolutions with the at least one Ngram for each of the plurality of past incident tickets;
for a given past incident ticket from the plurality of past incident tickets,
scoring each of the plurality of resolutions based on a number of matches; and
selecting the one or more resolutions from the plurality of resolutions based on scoring.

8. The method of claim 7, further comprising requesting clarification from a user in case of a conflict between the one or more resolutions having an identical score.

9. An incident ticket prediction device for predicting a relevant resolution for an incident ticket, the device comprising:
at least one processor; and
a computer-readable medium storing instructions that, when executed by the at least one processor, cause the at least one processor to perform operations comprising:
receiving the incident ticket;
analyzing the incident ticket to determine at least one query Ngram and at least one category;
determining a similar past incident ticket based on a comparison of the at least one query Ngram and at least one Ngram derived from each of a plurality of past incident tickets belonging to the at least one category; and
predicting the relevant resolution based on one or more resolution mapped to the similar past incident ticket.

10. The incident ticket prediction device of claim 9, wherein the analyzing the incident ticket comprises pre-processing the incident ticket.

11. The incident ticket prediction device of claim 9, wherein the operations further comprise:
validating the relevant resolution from a user;
for a negative validation, initiating a learning process based on intelligence gathered manual resolution of the incident ticket, wherein the incident ticket resulting in the negative validation is a new incident ticket unrelated to a plurality of past incident tickets and not having a mapped resolution; and
updating a ticket repository based on the learning process.

12. The incident ticket prediction device of claim 9, wherein the operations further comprise:
receiving a past ticket repository comprising a plurality of past incident tickets and a plurality of resolutions;
clustering the plurality of past incident tickets and the plurality of resolutions into a plurality of categories, wherein each category comprises a set of past incident tickets from the plurality of past incident tickets having at least one common characteristic;
determining at least one Ngram for each of the plurality of past incident tickets and for each of the plurality of resolutions;
mapping each of the plurality of past incident tickets with the one or more resolutions from the plurality of resolutions by analyzing the at least one Ngram for each of the plurality of past incident tickets with the at least one Ngram for each of the plurality of resolutions.

13. The incident ticket prediction device of claim 12, wherein the operations further comprise pre-processing the plurality of past incident tickets and the plurality of resolutions.

14. The incident ticket prediction device of claim 12, wherein the analyzing comprises:
iteratively matching the at least one Ngram for each of the plurality of resolutions with the at least one Ngram for each of the plurality of past incident tickets;
for a given past incident ticket from the plurality of past incident tickets,
scoring each of the plurality of resolutions based on a number of matches; and
selecting the one or more resolutions from the plurality of resolutions based on scoring.

15. The incident ticket prediction device of claim 14, wherein the operations further comprise requesting clarification from a user in case of a conflict between the one or more resolutions having an identical score.

16. A non-transitory computer-readable medium storing computer-executable instructions for:
receiving the incident ticket;
analyzing the incident ticket to determine at least one query Ngram and at least one category;
determining a similar past incident ticket based on a comparison of the at least one query Ngram and at least one Ngram derived from each of a plurality of past incident tickets belonging to the at least one category; and
predicting the relevant resolution based on one or more resolution mapped to the similar past incident ticket.

17. The non-transitory computer-readable medium of claim 16, wherein the analyzing the incident ticket comprises pre-processing the incident ticket.

18. The non-transitory computer-readable medium of claim 16 further storing computer-executable instructions for:
validating the relevant resolution from a user;
for a negative validation, initiating a learning process based on intelligence gathered manual resolution of the incident ticket, wherein the incident ticket resulting in the negative validation is a new incident ticket unrelated to a plurality of past incident tickets and not having a mapped resolution; and
updating a ticket repository based on the learning process.

19. The non-transitory computer-readable medium of claim 16 further storing computer-executable instructions for:
receiving a past ticket repository comprising a plurality of past incident tickets and a plurality of resolutions;
clustering the plurality of past incident tickets and the plurality of resolutions into a plurality of categories, wherein each category comprises a set of past incident tickets from the plurality of past incident tickets having at least one common characteristic;
determining at least one Ngram for each of the plurality of past incident tickets and for each of the plurality of resolutions;
mapping each of the plurality of past incident tickets with one or more resolutions from the plurality of resolutions by analyzing the at least one Ngram for each of the plurality of past incident tickets with the at least one Ngram for each of the plurality of resolutions.

20. The non-transitory computer-readable medium of claim 19, wherein the analyzing comprises:
iteratively matching the at least one Ngram for each of the plurality of resolutions with the at least one Ngram for each of the plurality of past incident tickets;
for a given past incident ticket from the plurality of past incident tickets,
scoring each of the plurality of resolutions based on a number of matches; and
selecting the one or more resolutions from the plurality of resolutions based on scoring.
